(19) United States
(12) Patent Application Publication
(10) Pub. No.: US 2018/0107963 A1
(43) Pub. Date: Apr. 19, 2018

(54) OPTIMIZING CLIENT WAIT TIMES AND INTERACTIONS

(71) Applicant: HRB Innovations, Inc., Las Vegas, NV (US)

(72) Inventors: Erin O'Flaherty, Kansas City, MO (US); John M. Kratofil, Overland Park, KS (US)

(21) Appl. No.: 15/296,581

(22) Filed: Oct. 18, 2016

(51) Int. Cl. G06Q 10/06; G06Q 10/10; G06Q 40/00

(52) U.S. Cl. CPC G06Q 10/063112; G06Q 40/123; G06Q 10/1095

(57) ABSTRACT

Media and methods allowing for accurate estimation of the time needed to perform complex professional services, based on the service or services requested of the professional, the historical time required to provide services for the client, and the historical speed of the professional in providing similar services previously. Accurate estimation of the time required to provide services in turn allows for accurate estimation of the length of a professional's waiting list. Thus, a client can easily compare the wait times for available professionals and find the professional that will be available soonest, and notify them when their spot in line will soon be serviced.

### BACKGROUND

### 1. Field

Embodiments of the invention generally relate to determining and optimizing wait times for a client to see a professional and, more particularly, to determining the time needed for each of a set of professionals to serve all of the waiting clients and choosing the best professional with the lowest waiting time.

### 2. Related Art

Traditionally, clients wishing to book an appointment with a professional must individually consult with potential professionals to find a mutually agreeable appointment time slot, and then choose the best of the available time slots for all professionals. Professionals, meanwhile, must set aside a fixed amount of time for each client so as to ensure that clients requiring complex services do not overrun their allotted times. However, due to the length of time required for professionals to service clients, allowing clients to drop in and join a waiting list results in unacceptable waiting times.

### SUMMARY

Embodiments of the invention allow for accurate estimation of the time needed to perform complex professional services, based on the service or services requested of the professional, the historical time required to provide services for the client, and the historical speed of the professional in providing similar services. Accurate estimation of the time required to provide services allows for accurate estimation of the length of a professional's waiting list. Thus, a client can easily find the professional that will be available soonest, and be notified when their spot in line will soon be serviced.

In particular, in a first embodiment, the invention includes one or more non-transitory computer-readable media storing computer-executable instructions that, when executed by a processor, perform a method of optimizing a wait time for a client, comprising the steps of determining one or more client requirements for a service to be performed for the client, determining a plurality of professionals meeting the one or more client requirements for the service, for each professional of the plurality of professionals determining a current waiting list for the professional comprising one or more waiting clients for the professional, estimating, for each waiting client, a time required for the professional to service the waiting client, estimating, for a client currently being serviced by the professional, a remaining time for the professional to service the current client, estimating a travel time needed for the client to reach the professional, and calculating an estimated wait time for the client based at least in part on the estimated wait times for the plurality of waiting clients, the estimated remaining time for the current client, and the estimated travel time, and determining a best professional based at least in part on the estimated wait time for each of the plurality of professionals.

In a second embodiment, the invention includes a method of estimating a time required for a professional to service a client, comprising the steps of determining one or more services required by the client, for each service of the one or more services required by the client determining a baseline time to perform the service, adjusting the baseline time based on an amount of time previously required to perform a similar service for the client, further adjusting the baseline time based on a relative amount of time required to perform another task for the client as compared to an amount of time required to perform the other task for other clients, and further adjusting the amount of time based on a relative amount of time for the professional to perform the service as compared to an amount of time for other professionals to perform the service to determine the adjusted time to perform the service, and summing the adjusted time to perform each of the plurality of services to obtain the estimated time for the professional to service the client.

In a third embodiment, the invention includes a method of optimizing a wait time for a client, comprising the steps of determining one or more client requirements for a service to be performed for the client, determining a plurality of professionals meeting the one or more client requirements for the service, for each professional of the plurality of professionals, determining a current waiting list for the professional comprising one or more waiting clients for the professional, for each waiting client of the one or more waiting clients determining one or more uncompleted services required by the waiting client, for each uncompleted service of the one of the more uncompleted services required by the waiting client, determining a baseline time to perform the uncompleted service, adjusting the baseline time based on an amount of time previously required to perform a similar service for the waiting client, further adjusting the baseline time based on a relative amount of time required to perform another task for the waiting client as compared to an amount of time required to perform the other task for other clients, and further adjusting the amount of time based on a relative amount of time for the professional to previously perform the uncompleted service as compared to an amount of time for other professionals to perform the uncompleted service to determine the adjusted time to perform the service, and summing the adjusted time to perform each of the plurality of uncompleted services to obtain the estimated time for the professional to service the waiting client, estimating a travel time needed for the client to reach the professional, and calculating an estimated wait time for the client based at least in part on the estimated times for the professional to service the plurality of waiting clients and the estimated travel time, and determining a best professional based at least in part on the estimated wait time for each of the plurality of professionals.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF THE DRAWING FIGURES

Embodiments of the invention are described in detail below with reference to the attached drawing figures, wherein:

FIG. 1 depicts an exemplary hardware platform for certain embodiments of the invention;

FIG. 2 depicts a diagram showing certain principals and data items present in certain embodiments of the present invention;

FIG. 3 depicts a flowchart depicting the operation of a method in accordance embodiments of the present invention; and

FIG. 4 depicts a flowchart illustrating a method of estimating the time required for a professional to serve a client.

The drawing figures do not limit the invention to the specific embodiments disclosed and described herein. The drawings are not necessarily to scale, emphasis instead being placed upon clearly illustrating the principles of the invention.

### DETAILED DESCRIPTION

At a high level, embodiments of the invention relate to estimating the amount of time until a professional will be available to see a waiting client, and to using such estimates to automatically select the best professional for the client to see or rank a list of professionals for the clients to see. In particular, the complexity (and therefore associated time) of each service to be performed by a professional for a waiting client can be estimated and then adjusted based on task-specific, client-specific, and professional-specific factors.

In many instances, a variety of professionals in a given field may be available to serve each client. These professionals can be filtered based on their qualifications or the services they offer to give a list of potential professionals. By performing wait-time estimates for each client on the waiting list of each potential professional, the total wait time for each professional can be estimated. Because different professionals may be located at different distances from a potential client, the travel time to reach the location of each professional can also be estimated and incorporated into the total wait time for the professional. The best (or simply first available) professional can then be selected based on their respective wait times.

The subject matter of embodiments of the invention is described in detail below to meet statutory requirements; however, the description itself is not intended to limit the scope of claims. Rather, the claimed subject matter might be embodied in other ways to include different steps or combinations of steps similar to the ones described in this document, in conjunction with other present or future technologies. Minor variations from the description below will be obvious to one skilled in the art, and are intended to be captured within the scope of the claimed invention. Terms should not be interpreted as implying any particular ordering of various steps described unless the order of individual steps is explicitly described.

The following detailed description of embodiments of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the invention. The following detailed description is, therefore, not to be taken in a limiting sense. The scope of embodiments of the invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate reference to “one embodiment” “an embodiment”, or “embodiments” in this description do not necessarily refer to the same embodiment and are also not mutually exclusive unless so stated and/or except as will be readily apparent to those skilled in the art from the description. For example, a feature, structure, or act described in one embodiment may also be included in other embodiments, but is not necessarily included. Thus, the technology can include a variety of combinations and/or integrations of the embodiments described herein.

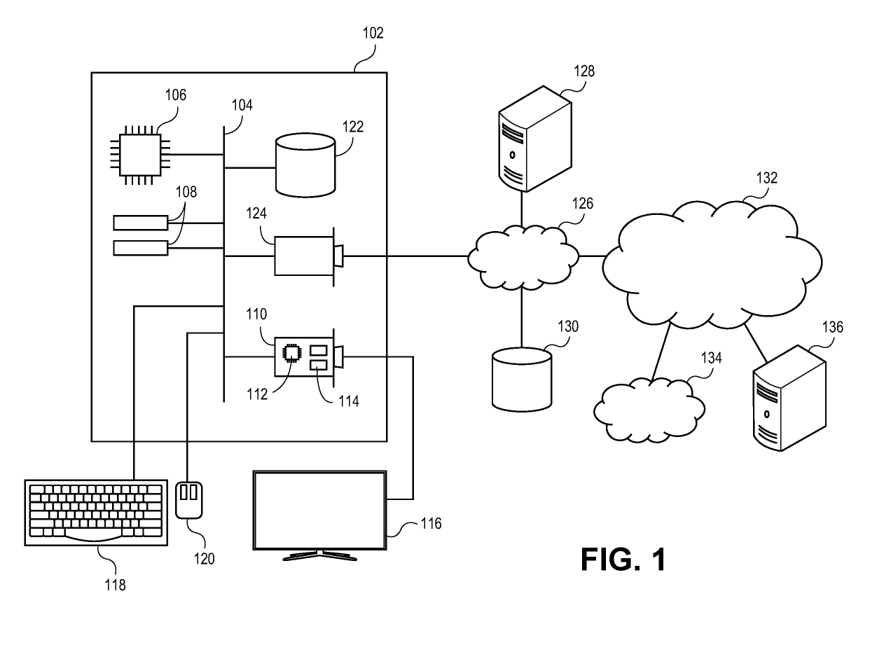

Turning first to FIG. 1, an exemplary hardware platform for certain embodiments of the invention is depicted. Computer 102 can be a desktop computer, a laptop computer, a server computer, a mobile device such as a smartphone or tablet, or any other form factor of general- or special-purpose computing device. Depicted with computer 102 are several components, for illustrative purposes. In some embodiments, certain components may be arranged differently or absent. Additional components may also be present. Included in computer 102 is system bus 104, whereby other components of computer 102 can communicate with each other. In certain embodiments, there may be multiple busses or components may communicate with each other directly. Connected to system bus 104 is central processing unit (CPU) 106. Also attached to system bus 104 are one or more random-access memory (RAM) modules. Also attached to system bus 104 is graphics card 110. In some embodiments, graphics card 104 may not be a physically separate card, but rather may be integrated into the motherboard or the CPU 106. In some embodiments, graphics card 110 has a separate graphics-processing unit (GPU) 112, which can be used for graphics processing or for general purpose computing (GPGPU). Also on graphics card 110 is GPU memory 114. Connected (directly or indirectly) to graphics card 110 is display 116 for user interaction. In some embodiments no display is present, while in others it is integrated into computer 102. Similarly, peripherals such as keyboard 118 and mouse 120 are connected to system bus 104. Like display 116, these peripherals may be integrated into computer 102 or absent. Also connected to system bus 104 is local storage 122, which may be any form of computer-readable media, and may be internally installed in computer 102 or externally and removeably attached.

Computer-readable media include both volatile and nonvolatile media, removable and nonremovable media, and contemplate media readable by a database. For example, computer-readable media include (but are not limited to) RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data temporarily or permanently. However, unless explicitly specified otherwise, the term “computer-readable media” should not be construed to include physical, but transitory, forms of signal transmission such as radio broadcasts, electrical signals through a wire, or light pulses through a fiber-optic cable. Examples of stored information include computer-usable instructions, data structures, program modules, and other data representations.

Finally, network interface card (NIC) 124 is also attached to system bus 104 and allows computer 102 to communicate over a network such as network 126. NIC 124 can be any form of network interface known in the art, such as Ethernet, ATM, fiber, Bluetooth, or Wi-Fi (i.e., the IEEE 802.11 family of standards). NIC 124 connects computer 102 to local network 126, which may also include one or more other computers, such as computer 128, and network storage, such as data store 130. Generally, a data store such as data store 130 may be any repository from which information can be stored and retrieved as needed. Examples of data stores include relational or object oriented databases, spreadsheets, file systems, flat files, directory services such as LDAP and Active Directory, or email storage systems. A data store may be accessible via a complex API (such as, for example, Structured Query Language), a simple API providing only read, write and seek operations, or any level of complexity in between. Some data stores may additionally provide management functions for data sets stored therein such as backup or versioning. Data stores can be local to a single computer such as computer 128, accessible on a local network such as local network 126, or remotely accessible over Internet 132. Local network 126 is in turn connected to Internet 132, which connects many networks such as local network 126, remote network 134 or directly attached computers such as computer 136. In some embodiments, computer 102 can itself be directly connected to Internet 132.

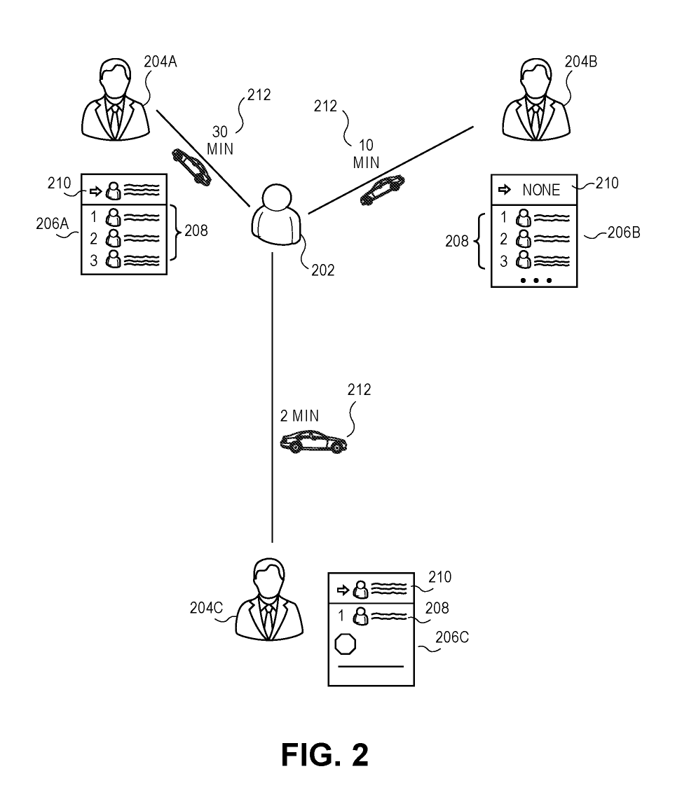

Turning now to FIG. 2, a diagram showing certain principals and data items present in certain embodiments of the present invention is depicted and referred to generally by reference numeral 200. Initially, client 202 is an institution or representative of a juristic entity seeking the service of a professional such as professional 204a, 204b, or 204c (generically referred to as professional 204). Broadly, professional 204 may provide any service useful to client 202. For example, professional 204 might be a salesperson providing specialized advice, experience, or attention (such as a salesperson at a car dealership). Similarly, professional 204 might be a licensed professional such as a doctor or lawyer, or a skilled worker in a service industry, such as a hairdresser. As another example, professional 204 may simply be one of a number of servers at a restaurant or restaurant chain. For the sake of simplicity and brevity through this specification, the example where professional 204 is a tax professional preparing a tax return for client 202, a taxpayer will be used. However, one of skill in the art will appreciate that embodiments of the invention may be practiced in the above-described industries or any of a variety of others.

Associated with each professional 204 is a respective waiting list 206 (respectively, waiting lists 206a, 206b, and 206c for professionals 204a, 204b, and 204c). Each waiting list includes other clients such as client 202 who are currently queueing for the services of professional 204. In some embodiments, professional 204 sees the first of the unseen clients 208 as soon as they have finished serving current client 210. In other embodiments, each of the unseen clients 208 may have an appointment time. As such, it may be the case that professional 204 is not currently serving a current client (as is the case with professional 204b). In some embodiments, there maybe an unlimited number of entries on waiting list 206. In other embodiments, the waiting list may be limited or otherwise closed, as shown in waiting list 206a. For example, professional 204 may have limited office hours such that unseen clients 208 will occupy all of the remaining time until professional 204 leaves for the day.

Also associated with each professional 204 in some embodiments is a travel time 212 to the location of that professional for client 202. For example, as depicted, client 202 has a travel time of 30 minutes to professional 204a, 10 minutes to professional 204b, and 2 minutes to professional 204c. In some embodiments, this time is automatically calculated based on a determined location of client 202 and a stored location for professional 204. In some such embodiments, the travel time may be calculated for a particular method of travel, such as walking, driving, or traveling by public transportation.

In some embodiments, each professional 204 may be further associated with certain qualifications, specializations, or services offered. For example, in the tax preparation space, exemplary qualifications might include one tax professional being a Certified Public Accountant, another being a Tax Attorney, and a third being an IRS enrolled agent. Similarly, examples of specializations might include farm income, self-employment income, pass-through income, or any area of specialization, as discussed in greater detail below. In still other embodiments, different professionals may offer different services. For example, a first tax professional might prepare only basic tax returns, a second tax professional might prepare corporate taxes, and a third might offer tax-planning services in addition to tax preparation services.

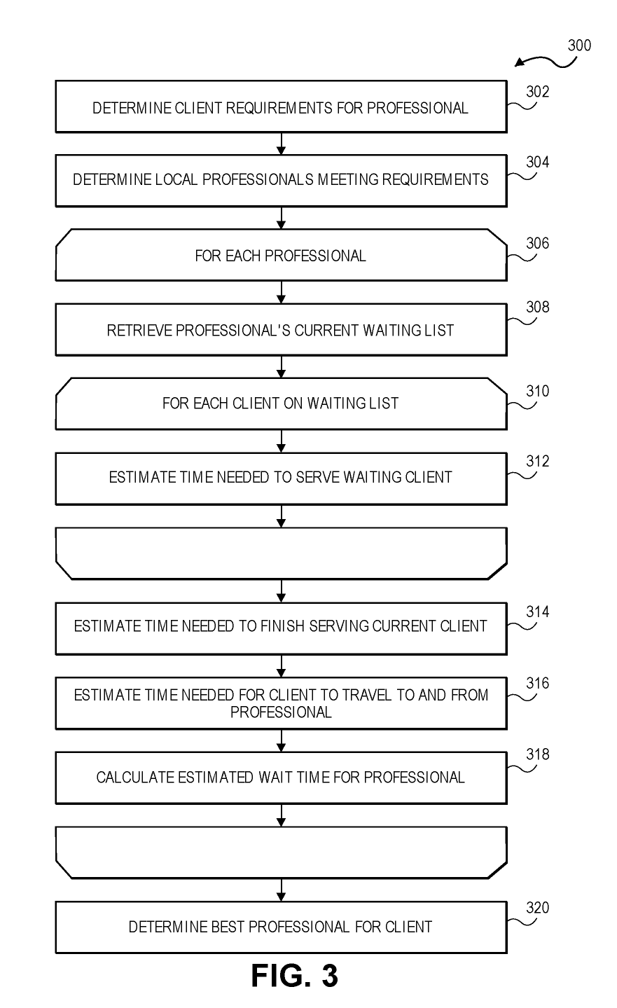

Turning now to FIG. 3, a flowchart depicting the operation of a method in accordance with embodiments of the present invention is depicted and referred to generally by reference numeral 300. Initially, at a step 302, the initial client requirements for a professional are determined. In some embodiments, the client requirements for the professional are determined automatically. For example, a client's prior-year tax returns or tax transcripts might indicate that they have corporation pass-through income. For such a client, the system might automatically add a requirement for a professional qualified to prepare a tax return including pass-through income. In other embodiments, the client can specify their requirements. For example, a client might specify the same need for a professional qualified to prepare a tax return including pass-through income the professional, a preference for a Certified Public Account, or a need for tax planning services. In some embodiments, client requirements might also include constraints on the location of the tax professional's office, on times at which the tax professional can meet, or on the price the client is willing to pay. In some embodiments, clients might specify that the professional have at least a specified customer satisfaction rating, at least a given number of years of experience, or a lower-than-specified error rate or audit rate.

Next, at step 304, the set of available professionals meeting the client requirements ascertained at step 302 is determined. In some embodiments, the client requirements might be compared against a stored list of qualifications for professionals. In other embodiments, the requirements may be sent to each available professional to solicit responses from those professionals meeting the requirements. In still other embodiments, a hybrid of these two methods, whereby a first portion of the requirements are used to determine a set of professionals to whom to send the remaining qualifications. For example, the set of all professionals may be filtered based on the client's geographic requirements, and all nearby professionals are solicited to determine whether they have the subject-matter expertise required by the client. Once the set of professionals meeting the client's requirements has been determined at step 304, processing can proceed to loop 306, where the best professional to serve the client is determined. Loop 306 repeats steps 308 through 320 for each professional meeting the client's requirements.

First, at step 308, the current waiting list for the professional is retrieved. In some embodiments, a shared calendaring system is used to determine waiting list 206 for each professional. In other embodiments, a dedicated waiting list system shared between all professionals is used. In still other embodiments, the individual waiting list for each professional is queried. In some embodiments, additional information may be retrieved for each client on the waiting list. For example, the requirements provided by that client, a likelihood that the client will cancel or otherwise give up their slot on the waiting list, or (for a client currently being seen) an estimated fraction of the service that has already been performed may be retrieved. Processing then proceeds to loop 310, which repeats step 312 for each client on the professional's waiting list.

At step 312, the time required to serve the client on the waiting list is estimated. The estimated time to serve each client may vary significantly from client to client and from professional to professional, as described in greater detail below with respect to method 400. As described there, the time to perform each service (or sub-service) for the particular client by the particular professional is estimated. By summing the time estimates for each service (or sub-service) for the client, the total time to serve that waiting client can be estimated.

Once the estimated time to serve each client has been estimated, processing can proceed to step 314, where the remaining time required to serve the client currently being seen by the professional is estimated. This process is broadly similar to method 400; however, services or sub-services which have already been completed can be ignored, and estimated progress can be used to reduce the remaining time required for the service currently being performed. For example, if a haircut is estimated to require twenty minutes, and began eight minutes ago, it can be estimated that the haircut will be finished in twelve minutes. Alternatively or in addition, progress through the service can be used to estimate the time remaining. For example, if a given service requires asking the client fifty questions and is estimated to take sixty minutes, and if twenty-five of those questions have been asked and answered, then the remaining time can be estimated to be thirty minutes. As yet another alternative, these to methods can be combined: if a particular service is half done (for example, twenty-five of fifty questions have been completed) and began eight minutes ago, it can be estimated that eight more minutes will be required to complete the task. One of skill in the art will appreciate that many additional techniques for estimating the time remaining to complete a service can be employed without departing from the scope of the invention.

Next, at step 316, the time required for the client to travel to and/or from that professional is determined. In some embodiments, professionals at multiple office locations are considered when selecting a professional for client, as depicted in FIG. 2. In order to accurately predict the wait time for a client at a distant office, the travel time to and/or from that office must be determined. In some embodiments, the client supplies their starting location and/or their final destination after the appointment so that the travel times to and from the known location of each office can be calculated. In other embodiments, the present location of the client (as determined by, for example, a GPS receiver or other location-determining component in the client's personal telecommunications device) is used as the starting location. In some embodiments, travel time after the appointment may be disregarded.

In some embodiments, travel time is calculated for travel via personal automobile. In other embodiments, travel time is calculated for walking, or for travel via public transit. In some such embodiment, the client may be given the option to select their preferred method of travel. The travel time calculation may depend on the chosen method of travel. For example, when travel by automobile is selected, the travel time might be calculated based on the length, speed limit, and number of traffic lights for each segment of road to be traveled, travel time by walking might be calculated based on the straight-line (or road) distance alone, and the travel time by public transport might be calculated based on posted bus schedules. One of skill in the art will appreciate that any method of transportation or of calculating travel times, now known or later developed, can be employed without departing from the scope of the invention.

Processing can then proceed to step 318, where the total wait time for the client for the professional in question is calculated. In some embodiments, the wait time is calculated as the time before the client can be first seen by the professional. In such embodiments, the wait time may be calculated as the greater of the total time for the professional to finish serving the other clients on the waiting list and the travel time to the location of that professional. In other embodiments, the wait time may be calculated as the amount of time the client must wait after arriving at the location of the professional, or by subtracting the travel time from the total time for the professional to finish serving the other clients on the waiting list. In still other embodiments, the wait time is calculated as the time until the client arrives at their destination after the appointment, by adding the total time for the professional to finish serving the other clients on the waiting list, the estimated time for that professional to serve the client, and the time to travel from the location of the professional to the client's final destination.

Finally, at step 320, once the wait time for each professional has been calculated, the best professional for the client can be determined. In some embodiments, the professional is determined based on the smallest wait time as calculated in the previous step. In other embodiments, additional factors (such as a client preference for lower travel time or lower cost) may also be taken into account. In some embodiments, information regarding the best professional is presented to the client. In other embodiments, an appointment with the best professional may automatically be booked, or the client may be added to the best professional's waiting list. In still other embodiments, an appointment slot is reserved and presented to the client to confirm the booking.

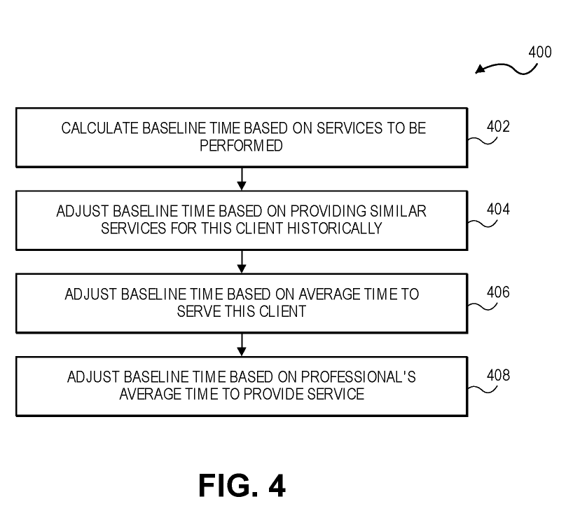

Turning now to FIG. 4, a flowchart illustrating a method of estimating the time required for a professional to serve a client is depicted and referred to generally by reference numeral 400. Initially, a baseline time is calculated based on the complexity of the service or services to be performed. Broadly speaking, the initial baseline depends on the services being performed, but not on the client or the professional. For example, it may be the case that a man's haircut is estimated to take 15 minutes, a woman's haircut is estimated to take 30 minutes, a shampoo is estimated to take 10 minutes, and a coloring is estimated to take 90 minutes. Thus, an appointment for woman to have her hair cut and colored might be have a baseline time of 2 hours, while an appointment for a man to have a haircut and shampoo might be estimated to take 25 minutes.

In some embodiments, complex or variable services may be broken up into sub-services that are estimated individually. For example, it may be the case that tax preparation software breaks the process of conducting the tax interview into a series of modular pages and only presents the relevant pages based on the complexity of a return or based on a preliminary interview. The initial baseline can then be calculated by associating an average or specific time with each page, and adding the page times for each page that is to be presented for the client in question. In some embodiments, the services to be performed (or the complexity of the service(s) to be performed) is determined via a simple questionnaire or interview when the service is being scheduled. For example, in the context of tax preparation, a 1040EZ return would have a low complexity (and therefore a low associated baseline time), a 1040A would have a moderate complexity, and a 1040 with associated schedules (e.g., an Earned Income Tax Credit schedule, a Schedule A for itemized deductions, a Schedule C for business income, a Schedule D for investment income, and so on) would have a high complexity, increasing with each associated schedule. This initial baseline may then be adjusted based on a variety of figures, as is discussed in greater detail below.

Next, at step 404, the baseline time for each service is adjusted based on the time required to provide similar services to that client in the past. For example, if the client making the appointment to cut and color her hair has previously had her hair colored, it may increase accuracy to choose the baseline value based on the actual time to previously complete the hair coloring. Similarly, it may be significantly more accurate to estimate the time required to interview a client about their income tax deductions based on their deduction interview from a prior year than based on an average across all users.

Processing can then proceed to step 406, where the baseline time for each service is further adjusted based on the average time to perform services for the client as compared to performing those same services for other users. For example, if it takes 25% longer to cut the hair of a particular client than of the average client, it may be likely that it will also take 25% longer to shampoo their hair than to shampoo the hair of the average client. In some embodiments, only some services are adjusted based on the client's average service time. For example, it may be the case that coloring a client's hair is mainly waiting time and is highly consistent from client to client. In such cases, the service in question is not adjusted by the client's average service time.

Next, at step 408, the baseline time for each service is further adjusted based on the average service time for the professional. For example, it may be the case that a given professional takes, on average, 25% less time to complete a service than the average professional. In such a case, the baseline time for a service may be decreased to reflect the professional's speed. In some embodiments, the baseline time is adjusted based on the average time for the professional to perform that particular service as compared to other professionals. In other embodiments, it may be the case that the baseline time is adjusted based on the average time for the professional to perform all services as compared to other professionals. In some embodiments, all services are adjusted in this manner. In other embodiments, only some services are adjusted in this manner. Based on these adjustments, the total time to service the client can be accurately estimated. In some embodiments, the client can be notified of the estimated time to for their service to be completed. In some embodiments, waiting clients can be notified when the total time for all services ahead of them in line drops below a given threshold so that they can leave for their appointment. IN some such embodiment, this threshold depends on the travel time calculated to the location of that professional, as discussed above.

Many different arrangements of the various components depicted, as well as components not shown, are possible without departing from the scope of the claims below. Embodiments of the invention have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims. Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. One or more non-transitory computer-readable media storing computer-executable instructions that, when executed by a processor, perform a method of optimizing a wait time for a client, comprising the steps of:
determining one or more client requirements for a service to be performed for the client;
determining a plurality of professionals meeting the one or more client requirements for the service;
for each professional of the plurality of professionals:
determining a current waiting list for the professional comprising one or more waiting clients for the professional;
estimating, for each waiting client, a time required for the professional to service the waiting client;
estimating, for a current client being serviced by the professional, a remaining time for the professional to service the current client; and
calculating an estimated wait time until the professional is available based at least in part on the estimated times for the professional to service the plurality of waiting clients and the estimated remaining time for the current client; and
determining a best professional based at least in part on the estimated wait time for each of the plurality of professionals.

2. The media of claim 1, wherein the method further comprises the step of automatically scheduling an appointment for the client with the best professional.

3. The media of claim 1, wherein the professional is a tax professional and the service comprises tax preparation.

4. The media of claim 1, wherein the estimated wait time is further based on an estimated time required to service the client.

5. The media of claim 1, further comprising the step of estimating a travel time needed for the client to reach the professional, and
wherein the estimated wait time is further based on the estimated travel time.

6. The media of claim 5,
wherein the method further comprises the step of receiving, from the client, a preferred method of travel; and
wherein the travel time is estimated based on the client's preferred method of travel.

7. The media of claim 1, wherein the estimated wait time is further based on an estimated time for the client to travel from the professional to a final destination.

8. A method of estimating a time required for a professional to service a client, comprising the steps of:
determining one or more services required by the client;
for each service of the one or more services required by the client:
determining a baseline time to perform the service;
adjusting the baseline time based on an amount of time previously required to perform a similar service for the client;
further adjusting the baseline time based on a relative amount of time required to perform another task for the client as compared to an amount of time required to perform the other task for other clients; and
further adjusting the amount of time based on a relative amount of time for the professional to perform the service as compared to an amount of time for other professionals to perform the service to determine the adjusted time to perform the service; and
summing the adjusted time to perform each of the plurality of services to obtain the estimated time for the professional to service the client.

9. The method of claim 8, wherein the similar service is an identical service.

10. The method of claim 8, wherein the professional is a tax professional and the one or more services include tax preparation.

11. The method of claim 8, further comprising the step of estimating a travel time for the client to reach the professional, and wherein the estimated time for the professional to service the client further includes the estimated travel time for the client to reach the professional.

12. The method of claim 8, wherein the one or more services comprise one or more sub-services making up a complex service.

13. The method of claim 8, further comprising the step of notifying the client of the estimated time for the professional to service the client.

14. The method of claim 8, wherein the baseline time is based on a complexity of the service.

15. A method of optimizing a wait time for a client, comprising the steps of:
determining one or more client requirements for a service to be performed for the client;
determining a plurality of professionals meeting the one or more client requirements for the service;
for each professional of the plurality of professionals:
determining a current waiting list for the professional comprising one or more waiting clients for the professional;
for each waiting client of the one or more waiting clients:
determining one or more uncompleted services required by the waiting client;
for each uncompleted service of the one of the more uncompleted services required by the waiting client:
determining a baseline time to perform the uncompleted service;
adjusting the baseline time based on an amount of time previously required to perform a similar service for the waiting client;
further adjusting the baseline time based on a relative amount of time required to perform another task for the waiting client as compared to an amount of time required to perform the other task for other clients; and
further adjusting the amount of time based on a relative amount of time for the professional to previously perform the uncompleted service as compared to an amount of time for other professionals to perform the uncompleted service to determine the adjusted time to perform the service; and
summing the adjusted time to perform each of the plurality of uncompleted services to obtain the estimated time for the professional to service the waiting client;
estimating a travel time needed for the client to reach the professional; and
calculating an estimated wait time for the client based at least in part on the estimated times for the professional to service the plurality of waiting clients and the estimated travel time; and
determining a best professional based at least in part on the estimated wait time for each of the plurality of professionals.

16. The method of claim 15, wherein the professional is a tax professional and the service comprises tax preparation.

17. The method of claim 15, wherein the travel time is calculated based on a method selected from the group consisting of travel by personal automobile, walking, and public transportation.

18. The method of claim 15, wherein one or more client requirements for the service include a qualification of the professional.

19. The method of claim 15, further comprising the step of notifying the client of the estimated wait time for the best professional.

20. The method of claim 15, further comprising the step of automatically booking an appointment for the client with the best professional.
